(19) United States
(12) Patent Application Publication
(10) Pub. No.: US 2005/0262748 A1
(43) Pub. Date: Dec. 1, 2005

(54) Combination necklace and collectible card holder

(76) Inventor: Carla M. Curtis, St. Louis, MO (US)

Correspondence Address: Caroline G. Chicoine;Thompson Coburn LLP, One US Bank Plaza, St. Louis, MO, 63101, US

(21) Appl. No.: 10/854,956

(22) Filed: May 27, 2004

(51) Int. Cl. G09F 3/20

(52) U.S. Cl. 40/649; 40/586

(57) ABSTRACT

A combination necklace and collectible card holder is disclosed. The holder is operatively connected to the necklace and configured to receive and display a collectible card. A method of making such a necklace and collectible card holder is also disclosed.

### FIELD OF THE INVENTION

The present invention relates generally to an article intended to be worn around the neck of a person which includes a compartment for holding a collectible card.

### BACKGROUND OF THE INVENTION

The memorabilia industry has created a market for numerous collectible items such as trading cards. Collectors acquire these cards for a variety of reasons. Collectible cards generally have a picture of an athlete (or race car, thoroughbred horse, etc.) on the front and written information such as performance statistics on the reverse. The value of a collectible card is influenced primarily by the demand for the item or person displayed thereon and the condition of the card. For example, a card for a given rookie may be worth one dollar during the rookie's first season. If the rookie goes on to have a hall-of-fame career, the demand for that card will naturally increase. Likewise, a buyer will be willing to pay more for a card that is in mint condition than one that shows wear and tear.

Spectator events are especially suited for selling and wearing memorabilia. Shirts and hats are popular since a person can wear the item as a show of support. Given the fragile nature of collectible cards and the somewhat “rowdy” nature of spectator events (especially sports events), attendees at such events have been reluctant to purchase or bring collectible cards for fear they will be lost or damaged. In particular, the attendee can be expected to sit, stand, clap, eat and/or drink during the spectator event, any of which can damage the card or risk its loss, especially when the attendee is a child. There is thus a need for an article which can incorporate a collectible card and be displayed while protecting it from damage.

While the combination is not limited to the use of a beaded necklace, a primary intent is to combine a collectible card with a viewable holder attached to such a necklace. Beads in recent years have become much more popular as personal adornments in sports and entertainment settings beyond their use as parade throwables at Mardi Gras-type events. Presently beads are marketed to fans and spectators who want a reasonably-priced way to display team, human participant (such as jockey silks) or competing object (such as race car) colors. The combination thus offers the potential to accomplish through the use of a beaded necklace multiple purposes for the consumer.

### SUMMARY OF THE INVENTION

An article is disclosed which includes a necklace, a connector operatively connected to the necklace, and a holder operatively connected to the connector and defining a slot, the holder being sized and configured to receive a collectible card via the slot and to enclose the collectible card within the holder is disclosed.

The holder is connected to the connector such that removal of the collectible card is prevented, and comprises at least one clear surface through which the collectible card is visible. In one embodiment, the holder includes a front sheet made of material through which the collectible card is visible and having a front hole, a back sheet having a back hole, and a u-shaped spacer therebetween to define the slot configured to receive and enclose a collectible card, the front hole being substantially aligned with the back hole so that the connector may pass therethrough. The necklace may comprise a plurality of beads, and may be configured to fit over a person's head.

An article including only the necklace and the holder is also disclosed.

A method of making a combination necklace and collectible card holder, is also disclosed. The method includes providing a necklace, providing a collectible card holder, inserting a collectible card in the holder, and connecting the holder to the necklace. The method may further include offering the combination necklace and collectible card holder for sale at a spectator event. In one embodiment, the collectible card may have a subject wherein the spectator event is an event in which the subject is participating, and the step of providing a necklace may include providing a necklace having a plurality of beads.

### BRIEF DESCRIPTION OF THE DRAWINGS

FIG. 1 is a perspective view of an article in accordance with one embodiment of the present invention;

FIG. 2 is an exploded view of the holder of the article of FIG. 1; and

FIG. 3 is a side cross sectional view of the holder of the article of FIG. 1.

Corresponding reference characters indicate corresponding parts throughout the several views of the drawings.

### DETAILED DESCRIPTION OF THE PREFERRED EMBODIMENTS

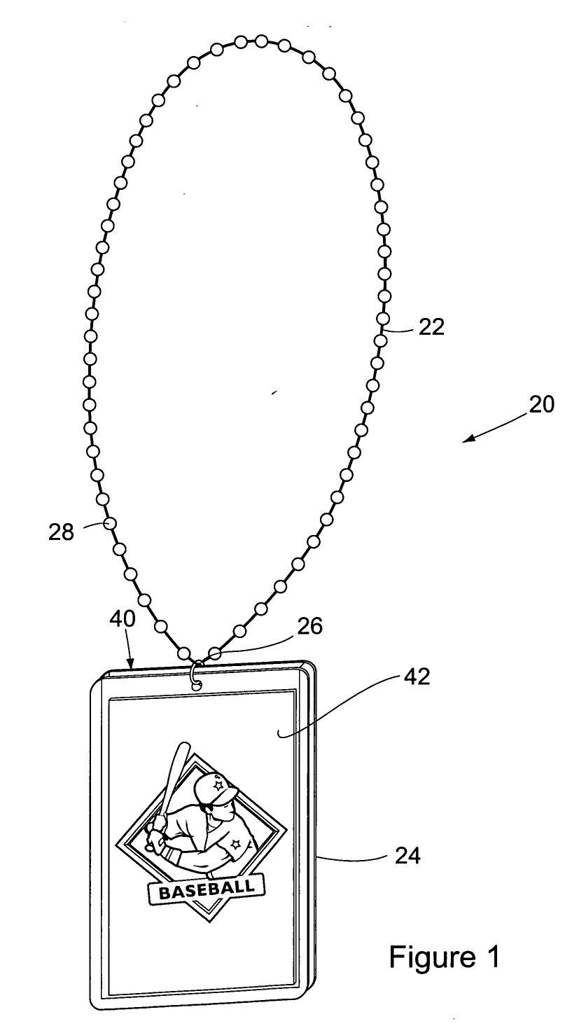

Referring now to the drawings, and more particularly to FIG. 1, a combination necklace/collectible card holder article 20 in accordance with one embodiment of the present invention is shown. The article includes a necklace 22, a collectible card holder 24, and a connector 26 for connecting the necklace 22 to the holder 24. The necklace 22 is sized and configured to fit over the head and around the neck of a person. It can be appreciated, however, that the necklace 22 may include a clasp or like device (not shown) for securing the necklace around a person's neck, especially if a shorter length necklace which does not fit over the head is desired. The necklace 22 may include a plurality of decorative elements 28 such as in the form of beads typical of necklaces used during Mardi Gras. However, decorative elements are not required and any type of necklace made of any type of material suitable for wearing around one's neck and connecting a collectible card holder thereto may be used.

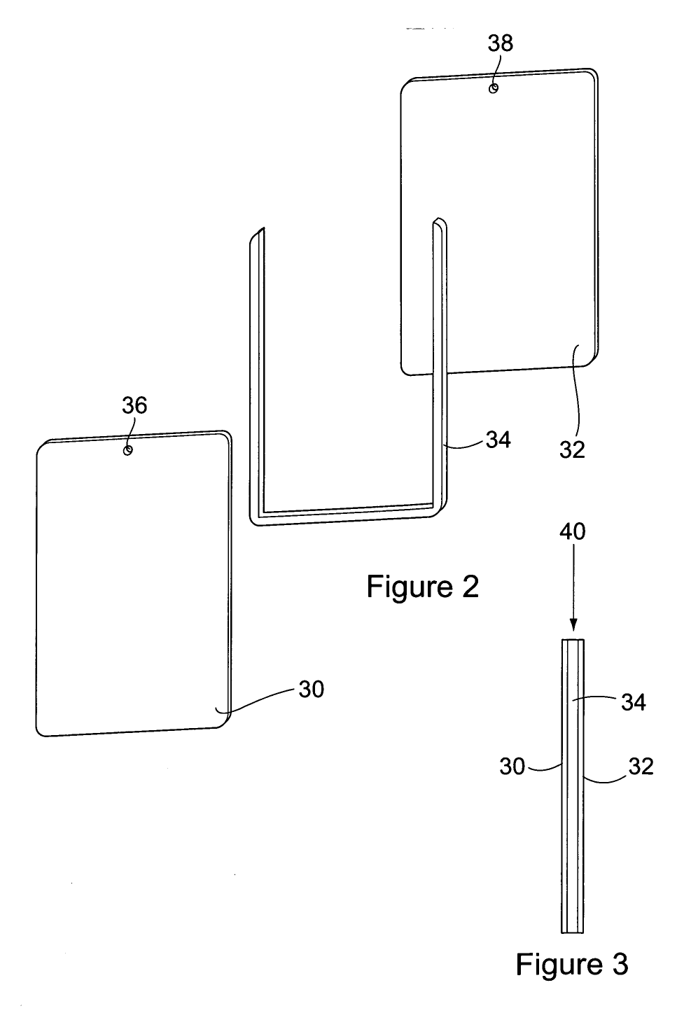

Referring now to FIGS. 2 and 3, a holder 24 in accordance with one embodiment of the present invention is shown. Holder 24 has a front sheet 30 of clear plastic, a back sheet 32 of clear plastic, and a unshaped spacer 34. The front sheet 30 defines a front hole 36 and the back sheet 32 defines a back hole 38. At least the front sheet is clear so that the front of the card is visible through it. Preferably, both the front sheet and the back sheet are clear and in one embodiment, they are made of clear plastic. The front and back sheets 30 and 37 are attached to the u-shaped spacer 34 through the use of heat and pressure such that the front and back holes 36 and 38 are substantially aligned so that the connector 26 can pass therethrough. A slot 40 is defined by the holder 24. The slot is shaped and configured to receive a collectible card and the card holder is shaped and configured to enclose a collectible card 42 received in the slot as shown in FIG. 1. While a baseball trading card is displayed in FIG. 1, it can be appreciated that any collectible card may be used. While the usual dimension of a collectible card is 2½ inches by 3½ inches, and the usual holder thus will be 3 inches by 4 inches, any sized card or holder may be used. The holder 24 is preferably flexible but somewhat resistant to bending to protect the collectible card from being creased or otherwise damaged. In addition, the holder 24 allows the collectible card to be viewed and handled without the need to directly handle the card itself. This further protects the card from being soiled or otherwise damaged. In addition, since the collectible card is not permanently enclosed within the holder, the owner of the card can remove the card from the holder 24 and display it in other ways or replace it with another card if desired. While the holder 24 is shown as being composed of three separate components (e.g., the u-shaped spacer, the front sheet and the back sheet), it can be appreciated that any holder made of any material suitable for enclosing a collectible card therein and having at least one surface through which the collectible card may be seen therethrough may be used.

The connector 26 primarily performs two functions. It attaches the holder 24 to the necklace 22. In addition, since the connector 26 passes through the front and back holes 36 and 38 of the front and back sheets 30 and 32, it acts to prevent a collectible card housed therein from falling out of the holder 24.

In use, the collectible card 42 is inserted into the slot 40 of the holder 24 until it is enclosed therein. The connector 24 can then be passed through the front and back holes 36 and 38 of the front and back sheets 30 and 32, and the connector can then be connected to the necklace 22. Alternatively, the connector 26 can first be connected to the necklace 22 and then connected to the holder 24. Once made, the combination necklace/collectible card holder may be offered or sold at spectator events and can include collectible cards of participants in the respective spectator event.

As various changes could be made in the above constructions and methods without departing from the scope of the invention, it is intended that all matter contained in the above description or shown in the accompanying drawings shall be interpreted as illustrative and not in a limiting sense. For instance, while the invention has been shown and described with a beaded necklace and baseball trading card, any type of necklace or lanyard and any type of collectible card may be used. In addition, any type of holder that protects the collectible card from damage and which allows the collectible card to be seen through it may be used. Thus, the breadth and scope of the present invention should not be limited by any of the above-described exemplary embodiments, but should be defined only in accordance with the following claims appended hereto and their equivalents.

1. An article comprising:
a necklace;
a connector operatively connected to the necklace; and
a holder operatively connected to the connector and defining a slot, the holder being sized and configured to receive a collectible card in the slot and to enclose the collectible card within the holder, the holder being spaced apart from the connector, and the connector being further configured to prevent removal of the collectible card from the holder.

2. (canceled)

3. The article of claim 1 wherein the holder comprises at least one clear surface through which the collectible card is visible.

4. The article of claim 2, wherein the holder defines a slot through which the collectible card may be received.

5. The article of claim 1, further comprising a collectible card housed within the holder.

6. The article of claim 1, wherein the necklace comprises a plurality of beads.

7. The article of claim 1, wherein the holder comprises:
a front sheet made of material through which the collectible card is visible and having a front hole;
a back sheet having a back hole; and
a u-shaped spacer therebetween to define a slot configured to receive and enclose a collectible card, the front hole being substantially aligned with the back hole so that the connector may pass therethrough.

8. The article of claim 1, wherein the necklace is configured to fit over a person's head.

9. An article comprising:
a necklace; and
a holder having a slot for receiving and enclosing a collectible card and attachment means spaced away from the collectible card for attaching the holder to the necklace, the attachment means being configured to prevent removal of the collectible card from the holder.

10. (canceled)

11. The article of claim 9, wherein the holder comprises at least one clear surface through which the collectible card is visible.

12. The article of claim 9, wherein the holder defines a slot through which the collectible card may be received.

13. The article of claim 9, further comprising a collectible card housed within the holder.

14. The article of claim 9, wherein the necklace comprises a plurality of beads.

15. The article of claim 9, wherein the holder comprises:
a front sheet made of material through which the collectible card is visible;
a back sheet; and
a u-shaped spacer therebetween to define the slot.

16. The article of claim 9, wherein the necklace is configured to fit over a person's head.

17. A method of making a combination necklace and collectible card holder, comprising:
providing a necklace;
providing a collectible card holder;
inserting a collectible card in the holder; and
connecting the holder to the necklace in a manner that keeps the collectible card intact and prevents the collectible card from being removed from the holder.

18. The method of claim 17, further comprising offering the combination necklace and collectible card holder for sale of a spectator event.

19. The method of claim 18, wherein the collectible card has a subject and wherein the spectator event is an event in which the subject is participating.

20. A method of claim 17, wherein the step of providing a necklace comprises providing a necklace having a plurality of beads.
